(19) United States
(12) Patent Application Publication
(10) Pub. No.: US 2001/0034606 A1
(43) Pub. Date: Oct. 25, 2001

(54) Method and system for providing design law resource center

(76) Inventors: Perry J. Saidman, Silver Spring, MD (US); Damon A. Neagle, Silver Spring, MD (US)

Correspondence Address: Perry J. Saidman, Esq., SAIDMAN DesignLaw Group, 1110 Bonifant Street, Suite 510, Silver Spring, MD, 20910, US

(21) Appl. No.: 09/772,302

(22) Filed: Jan. 29, 2001

Related U.S. Application Data
(60) Provisional application No. 60/178,586, filed on Jan. 28, 2000.

(51) Int. Cl. G06F 17/60

(52) U.S. Cl. 705/1

(57) ABSTRACT

An internet website providing information, services and products relating to legal issues (e.g., intellectual property protection) for designs. The types of designs includes industrial design, graphic design, architectural design, art design, and the like. The website is preferably located at the internet domain URL www.designlaw.com.

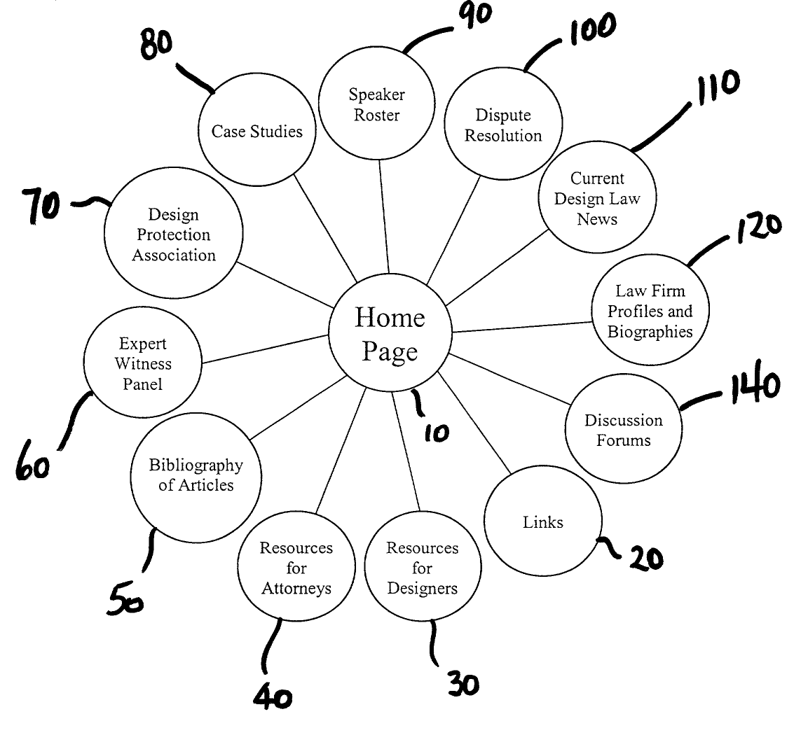

The website serves as a resource for anyone interested in the interplay between the law and design. The target audience includes designers, attorneys having design-related practices, and others interested in learning more about designs and protecting them with intellectual property rights. It will also cover basic legal concepts involving designs, such as who owns designs, contracts between designers and companies, and the like.

### CROSS-REFERENCE TO RELATED APPLICATION

This application claims the benefit of our prior provisional application Ser. No. 60/178,586, filed Jan. 28, 2000.

### SUMMARY OF THE INVENTION

The invention comprises an internet website providing information, services and products relating to legal issues (e.g., intellectual property protection) for designs. The types of designs can include industrial design, graphic design, architectural design, art design, and the like. The website will preferably be located at the internet domain URL www.designlaw.com.

The primary purpose of the website is to serve as a resource for anyone interested in the interplay between the law and design. The target audience will include designers, attorneys having design-related practices, and others interested in learning more about designs and protecting them with intellectual property rights. It will also cover basic legal concepts involving designs, such as who owns designs, contracts between designers and companies, and the like. Collectively, the interplay between design and the law will be referred to hereinafter as “design law”.

### BRIEF DESCRIPTION OF THE DRAWINGS

The foregoing and other aspects of the present invention will become more fully apparent from the following detailed description of the present invention when viewed in conjunction with the accompanying drawings, in which the sole drawing FIGURE comprises a schematic diagram of a preferred embodiment of a website according to the present invention.

### DETAILED DESCRIPTION OF THE PREFERRED EMBODIMENT

As illustrated in the sole drawing FIGURE, users of the website would first be directed to a home page 10 which serves as a gateway to the information, products and services offered on the site. The information, products and services available from home page 10 preferably include one or more of the following:

LINKS 20—Links 20 preferably comprise hyperlinks to other websites related to design law, including websites dedicated to: law firms that have one or more specialists in design law, design associations (e.g., Industrial Designers Society of America, Association of Professional Design Firms, etc.), U.S. and foreign patent, trademark and copyright agencies (e.g., USPTO, etc.), and existing laws and legislation (e.g., from the U.S. Congress, etc.).

RESOURCES FOR DESIGNERS 30—This category preferably comprises design law information written for designers relating to legal issues such as intellectual property protection for designs (such information may be offered as a free service or for a fee), patent litigation insurance, etc. This category may also include contact information for “design agents”, i.e., persons (not necessarily attorneys) who represent designers in negotiations with those manufacturers who may be interested in the marketing and sale of products embodying new designs. Finally, it may also include a marketplace for designs where designers can offer to license/sell their new designs to manufacturers.

RESOURCES FOR ATTORNEYS 40—This category would preferably provide design law information for attorneys who represent designers including, for example, articles on recent cases involving protection of designs (i.e., design patent cases, trade dress cases, trademark cases involving product configuration trademarks, and copyright cases). Information would also be presented on how to use utility patents to protect designs, and statistics on the effectiveness of litigation, etc. The category may also include a database from which attorneys can order images of products involved in design-related cases, and a periodic digest of the state of design law. Such attorney resource services could be offered for a fee.

BIBLIOGRAPHY OF ARTICLES 50—This product/service would comprise a list of articles relating to designs and design law, along with hyperlinks to the text of the articles (which may be offered as a free service or for a fee).

EXPERT WITNESS PANEL 60—This product/service preferably would include contact and bibliographical information for a group of legal and design experts in fields relating to design, including, e.g., design patent law, trade dress law, and industrial design. The website may further offer placement services between such experts and principals (e.g., litigators) for a fee.

DESIGN PROTECTION ASSOCIATION 70—This preferably comprises an association devoted to the protection of designs, mainly by intellectual property (e.g., design patents, utility patents, trade dress, copyright, etc.). The association's activities could include, for example, lobbying for improvements in U.S. and foreign laws relating to design protection, and operating a design protection co-operative. The design protection cooperative could, e.g., pool the resources of designers, design firms and companies that might not otherwise have the financial means to pursue infringers of their intellectual property rights. The co-operative, using its aggregate resources, would take court action against an infringer of a member of the cooperative. Criteria for such action would be governed by the associations board of governors.

CASE STUDIES 80—This product would preferably comprise brief presentations of cases and designs of current and/or historical interest, and could be offered on a fee or no-fee basis.

SPEAKER ROSTER 90—This product/service would provide information about people (e.g., designers, lawyers) who are available to speak to legal or designer groups on design law topics.

DISPUTE RESOLUTION 100—This product/service comprises information relating to the resolution of disputes involving designs, including legal remedies, alternative dispute resolution (e.g., mediation, arbitration), and contact information for experts in the field of design dispute resolution.

Current Design Law News 110—This product/service would provide information about current events relating to design law, including new and proposed legislation and regulatory changes, recent court decisions, and other events of interest to users of the website.

LAW FIRM PROFILES AND BIBLIOGRAPHIES 120—This product/service would provide information, including profiles and bibliographies, relating to law firms and attorneys who specialize in design law.

DISCUSSION FORUMS 140—This product/service may include chat rooms and bulletin boards where users of the website can communicate with one another about design and design law issues.

As described above, some of the information and services offered on the website would be offered on a fee basis. However, it is believed to be important that at least some the of the information be offered at no cost in order to establish the credibility of the persons and/or entity hosting the website as experts in the field of design law.

Obviously, numerous modifications of this method and system are possible. For example, not all of the resources noted above need be made available through the home page. One or more of the resources (e.g., The Design Protection Association) may be established as a separate entity with its own home page. Other resources in the field of design and law can be added as the need arises.

Further, it should be understood that the simplified structure of the website represented in the sole drawing FIGURE should not be limiting, inasmuch as it is representative only, and a more sophisticated website structure and/or architecture is anticipated as the website is constructed.

We claim as our invention:

1. A method of doing business using the Internet, comprising the steps of:
creating a website directed to issues involving design law;
creating a plurality of products and services of particular interest to designers, attorneys and members of the public that pertains to design law; and
offering said plurality of products and services through said website.

2. The method of doing business as set forth in claim 1, further comprising the step of providing a plurality of hyperlinks to other websites of possible interest to said designers, attorneys and members of the public.

3. The method of doing business as set forth in claim 2, wherein said hyperlinks include a hyperlink to the Industrial Designers Society of America.

4. The method of doing business as set forth in claim 1, wherein said plurality of products and services includes design law information written for designers.

5. The method of doing business as set forth in claim 1, wherein said plurality of products and services includes information pertaining to design agents who represent designers in negotiations with manufacturers.

6. The method of doing business as set forth in claim 1, wherein said plurality of products and services includes a marketplace for designs where designers can offer to sell or license their designs to manufacturers.

7. The method of doing business as set forth in claim 1, wherein said plurality of products and services includes design law information written especially for lawyers.

8. The method of doing business as set forth in claim 1, wherein said plurality of products and services includes a database of images of products and designs involved in design law litigation.

9. The method of doing business as set forth in claim 1, wherein said plurality of products and services includes a bibliography of articles relating to design law.

10. The method of doing business as set forth in claim 1, wherein said plurality of products and services includes information pertaining to a group of lawyers and designers who can serve as experts to others in design law litigation.

11. The method of doing business as set forth in claim 10, wherein said information includes placement services between said experts and third parties.

12. The method of doing business as set forth in claim 1, wherein said plurality of products and services includes a cooperative design protection association that designers can join to pool resources to enforce rights of members against infringers.

13. The method of doing business as set forth in claim 1, wherein said plurality of products and services includes written analysis of current and historical design law cases.

14. The method of doing business as set forth in claim 1, wherein said plurality of products and services includes information about people who are available to speak to legal and designer groups on design law topics.

15. The method of doing business as set forth in claim 1, wherein said plurality of products and services includes information relating to the resolution of disputes involving designs.

16. The method of doing business as set forth in claim 15, wherein said information includes alternative dispute resolution information.

17. The method of doing business as set forth in claim 1, wherein said plurality of products and services includes news about current developments in design law.

18. The method of doing business as set forth in claim 1, wherein said plurality of products and services includes a clearinghouse for referrals to attorneys who specialize in design law.

19. The method of doing business as set forth in claim 1, wherein said plurality of products and services includes a discussion forum where users of said website can communicate with one another about design and design law issues.

20. The method of doing business as set forth in claim 1, wherein said website is located at the Internet domain URL www.designlaw.com.
